(19) United States
(12) Patent Application Publication
(10) Pub. No.: US 2026/0217515 A1
(43) Pub. Date: Jul. 30, 2026

(54) LIFT AND CORRESPONDING SAFETY HARNESS DETECTION SYSTEM

(71) Applicant: TEREX SOUTH DAKOTA, INC., Watertown, SD (US)

(72) Inventor: John Fitts, Ephrata, WA (US)

(21) Appl. No.: 19/036,588

(22) Filed: Jan. 24, 2025

(51) Int. Cl. B66F 17/00

(52) U.S. Cl. CPC B66F 17/006

(57) ABSTRACT

A safety harness connection detector for a lift includes a limit switch that is operable to detect an attachment of a safety harness to the lift at a designated location on the lift. The safety harness connection detector is operable to generate a first warning in response to non-attachment of the safety harness at the designation location. The safety harness connection detector is operable to generate a second warning collectively with the first warning in response to non-attachment of the safety harness at the designation location and engagement of a secondary switch that is configured to enable operation of the lift.

### TECHNICAL FIELD

The disclosure relates to lift devices and safety harness systems for users operating lift devices.

### BACKGROUND

Lift devices may include platforms that may be elevated relative to a corresponding base structure.

### SUMMARY

A lift includes a base, a work platform, a human machine interface, a switch, and a detector. The work platform is attached to and movable relative to the base. The human machine interface is attached to the work platform. The human machine interface is operable for controlling movement of the work platform. The switch is attached to the work platform. The switch is operable to enable movement of the work platform via the human machine interface when engaged by a user. The switch is operable to disable movement of the work platform when disengaged by the user. The detector is attached to the work platform. The detector is operable to detect a connection of a safety harness lanyard to the work platform. The detector is operable to issue a first warning in response to non-detection of the connection of the safety harness lanyard to the work platform. The detector is further operable to simultaneously issue the first warning and a second warning in response to non-detection of the connection of the safety harness lanyard to the work platform and engagement of the switch.

A safety harness connection detector for a lift includes a switch. The switch is operable to detect an attachment of a safety harness to the lift at a designated location on the lift. The safety harness connection detector is operable to generate a first warning in response to non-attachment of the safety harness at the designation location. The safety harness connection detector is operable to generate a second warning collectively with the first warning in response to non-attachment of the safety harness at the designation location and engagement of a secondary switch. The secondary switch is configured to enable operation of the lift.

A safety harness connection detector for a lift includes a housing, a limit switch, and an extension arm. The housing is operable for connection to the lift. The limit switch is disposed within the housing. The limit switch is operable to detect an attachment of a safety harness to the lift at a designated location on the lift. The extension arm is connected to the limit switch. The extension arm extends away from the housing. The extension arm is operable to extend toward the designated location on the lift. The extension arm is operable to, in response to displacement of the extension arm, transition the limit switch to a first state corresponding to detection of the attachment of the safety harness to the lift at the designated location. The extension arm is further operable to, in response to non-displacement of the extension arm, transition the limit switch to a second state corresponding to non-detection of the attachment of the safety harness to the lift at the designated location.

### BRIEF DESCRIPTION OF THE DRAWINGS

FIG. 1 is a perspective view of an aerial lift vehicle according to an embodiment, illustrated in a partially extended position;

FIG. 2 is a perspective view of an aerial lift vehicle according to another embodiment, illustrated partially extended;

FIG. 3 is a perspective view of the aerial lift vehicle of FIG. 1, illustrated in a retracted position with the lift platform of the aerial lift vehicle in the foreground and the chassis of the aerial lift vehicle in the background;

FIG. 4 is a perspective side view of a safety harness connection detector as viewed externally from the lift platform including a safety harness that is attached to the lift platform;

FIG. 5 is a perspective side view of the safety harness connection detector as viewed internally from the lift platform including the safety harness that is attached to the lift platform;

FIG. 6 is a perspective side view of the safety harness connection detector as viewed internally from the lift platform excluding the safety harness;

FIG. 7 is diagram illustrating the interconnection between various elements of the aerial lift vehicle and the safety harness connection detector; and

FIG. 8 is a wire diagram illustrating the electrical elements of the safety harness connection detector and electrical connections between the electrical elements of the safety harness connection detector and the aerial lift vehicle.

### DETAILED DESCRIPTION

Embodiments of the present disclosure are described herein. It is to be understood, however, that the disclosed embodiments are merely examples and other embodiments may take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It is to be understood that the disclosed embodiments are merely exemplary and that various and alternative forms are possible. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ embodiments according to the disclosure.

It will also be understood that, although the terms first, second, etc. are, in some instances, used herein to describe various elements in order of introduction, these elements should not be limited by these terms. These terms are only used to distinguish one element from another.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

The terminology controller may be provided as one or more controllers or control modules for the various components and systems. The controller and control system may include any number of controllers, and may be integrated into a single controller, or have various modules. Some or all of the controllers may be connected by a controller area network (CAN) or other system. It is recognized that any controller, circuit, or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electrical devices as disclosed herein may be configured to execute a computer-program that is embodied in a non-transitory computer readable medium that is programmed to perform any number of the functions as disclosed herein.

Aerial lift assemblies provide an operator platform on a linkage assembly that rotates, pivots and/or translates to lift the operator platform to an elevated worksite. Aerial lift assemblies include various adjustable structures to lift an operator platform to a height for performing a work operation. The aerial lift assemblies often include a stack linkage assembly. The aerial lift assemblies often include an articulated boom assembly, which may be provided by a four-bar linkage mechanism or an extending riser type linkage. Aerial lift assemblies are often provided on land vehicles for transportation of operator platform to the worksite.

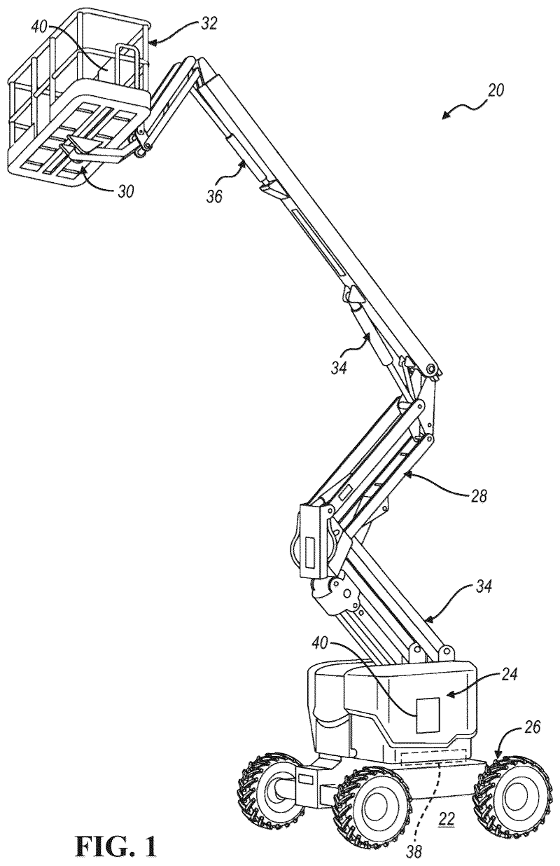

FIG. 1 illustrates a lift device 20, utility vehicle, aerial lift vehicle, or aerial lift assembly according to a first example and for use with the present disclosure. The lift device 20 may be used in a commercial or industrial environment and may include lift equipment, including a portable material lift, aerial work platform, telehandler, scissor lift, rough terrain telescopic load handler, and telescopic and articulating boom. The lift device 20 may be mobile on an underlying support surface, and the lift equipment may be retracted, collapsed, or otherwise stowed for transportation. The lift device 20 may be transportable for towing and transport upon a trailer behind a truck. In FIG. 1, the lift device 20 is illustrated as a telescopic and articulating boom according to a non-limiting example.

As shown, the lift device 20 is expandable or raised by operator control to lift an operator to an elevated worksite. The lift device may further include rotational movements in addition to translational movements to move the operator to the elevated worksite. The lift device 20 is configured for lifting a load, such as a person, tools, cargo, and the like, with respect to a support surface 22 or the underlying terrain, such as paved or unpaved ground, a road, an apron such as a sidewalk or parking lot, an interior or exterior floor of a structure, or other surfaces.

The lift device 20 includes a lift structure that provides significant stability and performance characteristics by elevating a worker to a selected position for reach while providing stability. The lift device 20 includes a chassis 24 to support the lift device 20 upon the ground 22 or any support surface. The chassis 24 is supported upon a plurality of wheels 26 that contact the ground 22 for support and mobility of the lift device 20. The chassis 24 may correspond to a base or base structure of the lift device 20.

A lift mechanism 28 is connected to the chassis 24 to extend and retract from the chassis 24. A lift platform 30 is provided on the lift mechanism 28 with a perimeter frame or railing 32. The lift platform 30 may also be referred to as a work platform. The lift platform 30 is attached to and movable relative to the chassis 24 via the lift mechanism 28. According to one embodiment, the lift mechanism 28 includes a plurality of linkages with an extendable boom. At least one actuator assembly 34 may be provided to pivot the linkages and the extendable boom, and another actuator assembly 36 may be provided to extend the boom. Furthermore, the lift platform 30 and lift mechanism 28 may be supported by a swing chassis 38 that is rotatably connected to the chassis 24, with an associated actuator assembly to rotate the swing chassis 38 relative to the chassis 24.

The lift device 20 may have a propulsion system with one or more motors to propel the wheels. In one example, the lift device has an electric propulsion system that acts to propel the vehicle, with one or more electric motors rotating the wheels. In a further example, each wheel may be provided with an associated electric motor to rotate the wheel, e.g. in a direct drive or hub motor configuration. The electric motor for propulsion of the wheel may be drivingly coupled to at least one wheel supported by the chassis to propel the lift vehicle. In other examples, the lift device 20 may be propelled via an internal combustion engine, or via a hybrid powered propulsion system.

The lift device 20 may also have a hydraulic system that operates the work function, such as actuator assemblies associated with the lift platform and lift mechanism 28, as well as actuators associated with other vehicle systems such as steering and/or oscillating axle(s).

The operator for the lift device 20 inputs commands to the lift device 20 via an operator input or user input 40. The operator input 40 may correspond to a control panel and/or a human machine interface. The operator input 40 may be attached to the lift platform 30 and may be operable for controlling movement of the lift platform 30 or more generally for controlling movement of the lift device 20. The operator input 40 may control the propulsion system to control the speed of the wheels. The operator input 40 may also provide for steering input, operator control of the position of the lift platform 30 relative to the chassis 24 via the lift mechanism 28, and the like. The operator input 40 may include control elements such control buttons, knobs, dials, touchscreens, joysticks, pedals, etc. A user or operator of the lift device 20 may engage the control elements to control movement of the lift platform 30 or more generally to control movement of the lift device 20.

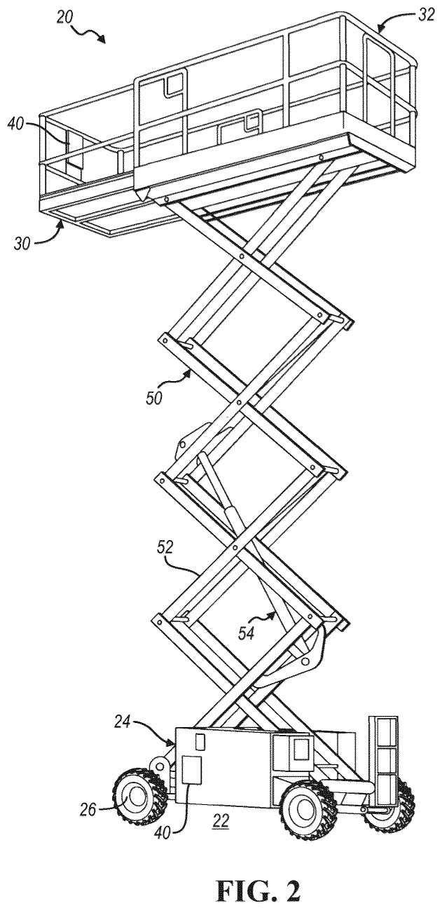

FIG. 2 illustrates a lift mechanism 50 according to another embodiment and for use with the present disclosure. Elements that are the same as or similar to those described above with respect to FIG. 1 are given the same reference number for simplicity.

In FIG. 2, the lift mechanism 50 is illustrated as a scissor lift or a stack linkage lift according to another non-limiting example. The lift mechanism 50 is utilized to lift the platform 30 and workers to elevated work locations to perform work operations. A linkage assembly 52 is connected to the chassis 24 to extend and retract from the chassis 24. A lift platform 30 is provided on the linkage assembly 28 to extend and retract from the chassis 24. The linkage assembly 52 is a stack linkage assembly 52, with a series of pivotally connected stack links that retract to collapse and stack upon the chassis 24 for compactness for storage and transportation. The lift mechanism 50 also includes an actuator assembly 54 to extend and retract the linkage assembly 52 and consequently, extend and retract the platform 30. The platform 30 includes perimeter railing 32 extending upward from the platform 30 to enclose an operator workspace upon the platform 30.

The lift mechanism 50 may additionally have a propulsion system as described above with respect to FIG. 1. The lift mechanism 50 may have hydraulic system that operates the work functions or load functions, such as lift actuator assembly(ies) 54 associated with the lift platform and lift linkage assembly 52, as well as actuators associated with other vehicle systems such as steering and/or oscillating axle(s). The operator for the lift mechanism 50 inputs commands to the lift device 20 via an operator input or user input 40 as described above with respect to FIG. 1.

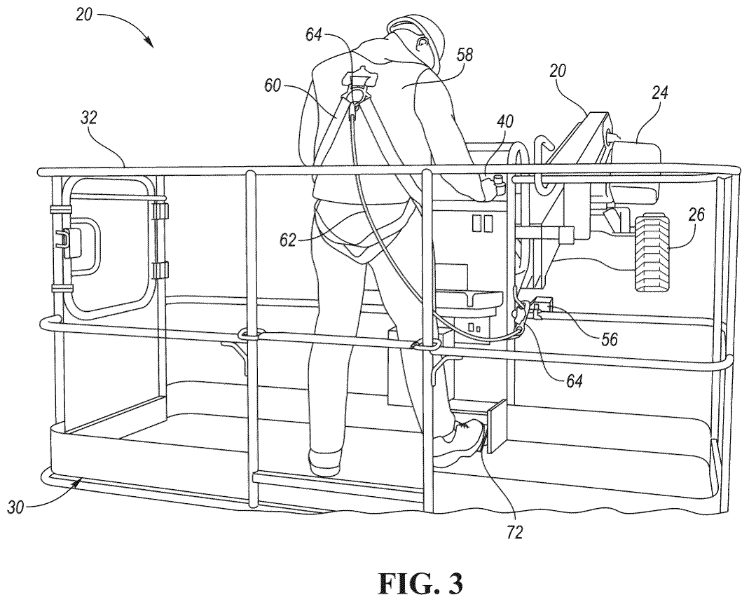

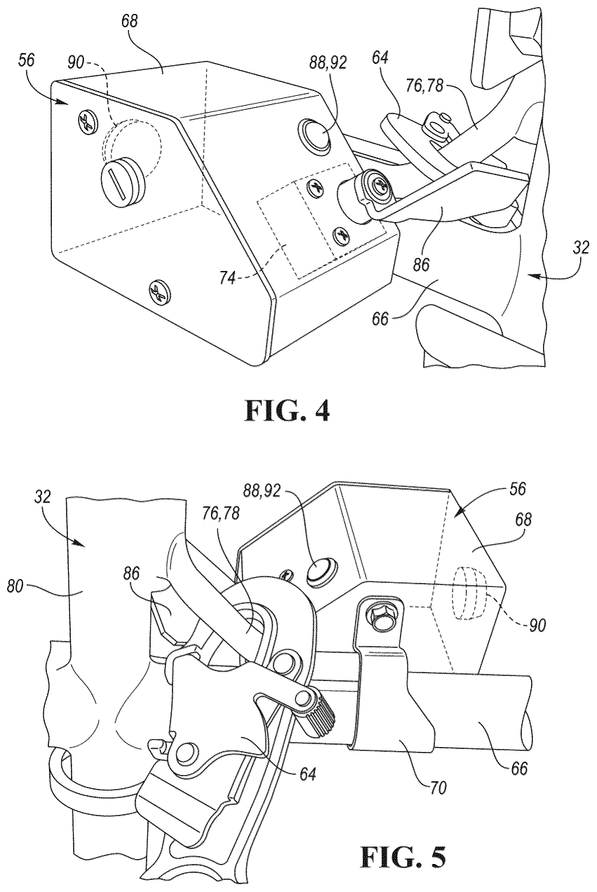

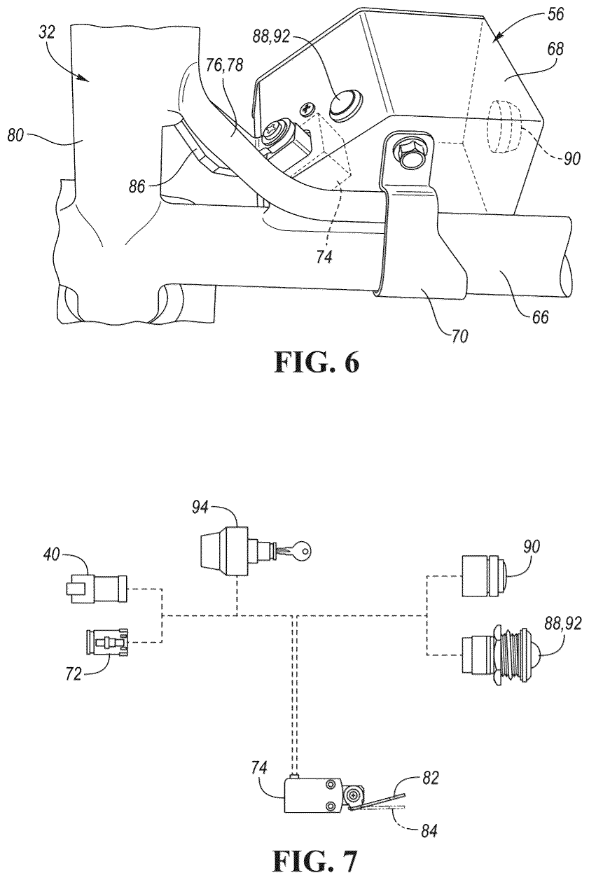

Referring to FIG. 3-7, a safety harness connection detector 56 for the lift device 20 is illustrated in further detail in conjunction with the lift device 20. It is noted that the safety harness connection detector 56 may be utilized in conjunction with lift device 20 as depicted in FIG. 1, with lift device 20 as depicted in FIG. 2, or in conjunction with any lift device or vehicle.

It may be necessary or required for a user or operator 58 that is operating the lift device 20 from the lift platform 30 to secure himself or herself to the lift platform 30. More specifically, the operator 58 may be fitted with a safety harness 60 (e.g., the harness 60 may be secured and/or attached to the operator 58) and a lanyard 62 may connect the harness 60 to the lift platform 30. The lanyard 62 may more specifically include clips 64 disposed at opposing ends of the lanyard 62, where a first of the clips 64 secures the lanyard 62 to the harness 60 (e.g., the first of the clips 64 is connected to ring on the harness 60) while the other of the clips 64 secures the lanyard 62 to the lift device 20, or more specifically to the lift platform 30 (e.g., the other of the clips 64 is connected to one the structural bars, tubes, members, etc. that form the perimeter frame or railing 32). The lanyard 62, including the clips 64, may be considered to be a part of the harness 60.

The safety harness connection detector 56 may be secured to one of the structural bars, tubes, members, etc. of the perimeter frame or railing 32. More specifically, the safety harness connection detector 56 may be secured to one of the cross-members 66 of the perimeter frame or railing 32 along an exterior of the perimeter frame or railing 32 so as to not obstruct the workspace of the operator 58 on the lift platform 30 within perimeter frame or railing 32. Even more specifically, the safety harness connection detector 56 may include an enclosure or housing 68, and the housing 68 may be secured to the perimeter frame or railing 32 via a strap or bracket 70.

The lift device 20 includes a switch 72 that is attached to the lift platform 30. The switch 72 is operable to enable movement of the lift platform 30, or more generally enable movement of the lift device 20 as a whole, via the operator input 40 when the switch 72 is engaged by the operator 58. The switch 72 may also be operable to disable movement of the lift platform 30, or more generally disable movement of the lift device 20 as a whole, via the operator input 40 when the switch 72 is disengaged by the operator 58. The switch 72, therefore, maybe referred to as a kill switch or a dead man switch since operation of the lift platform 30, or more generally operation of the lift device 20 as a whole, via the operator input 40 requires engagement between the operator 58 and the switch 72. The switch 72 may include or may comprise a foot pedal. Therefore, the switch 72 may be located along the floor or lower end of the lift platform 30 below the operator input 40.

The safety harness connection detector 56 is operable to detect a connection of the lanyard 62, or more generally the harness 60, to the lift device 20. More specifically, the safety harness connection detector 56 may include a switch 74 that is disposed in the housing 68 and is operable to detect an attachment of the lanyard 62, or more generally the harness 60, to the lift device 20 at a designated location on the lift device 20. Even more specifically, the switch 74 may be operable to detect an attachment of one of the clips 64 to the lift device 20 at a designated location 76 on the lift device 20, lift platform 30, or railing 32. The designated location 76 may correspond to a joining member 78 (e.g., a structural bar, tube, etc.) that extends between one the cross-members 66 of the perimeter frame or railing 32 and one of the upright or vertical members 80 (e.g., a structural bar, tube, etc.) of the perimeter frame or railing 32. The joining member 78 may be secured to the correspond cross-members 66 and vertical member 80 (e.g., via welding) to increase the structural integrity of the perimeter frame or railing 32. Switch 74 may comprise a limit switch. Switch 74 may be referred to as a primary switch while switch 72 may be referred to as a secondary switch, or vice versa.

The safety harness connection detector 56 is operable to generate or issue a first warning in response to non-detection of the connection of the lanyard 62, or more generally in response to non-detection of the connection of the harness 60, to the lift device 20, lift platform 30, or railing 32. The safety harness connection detector 56 is also operable to simultaneously or collectively issue or generate the first warning along with a second warning in response to non-detection of the connection of the lanyard 62, or more generally non-detection of the connection of the harness 60, to the lift device 20, lift platform 30, or railing 32 and engagement of the switch 72. Non-detection of the connection of the lanyard 62, or more generally non-detection of the connection of the harness 60 to the lift device 20, lift platform 30, or railing 32, may correspond to a non-detection of the connection of clip 64 at the designated location 76 (e.g., an absence of the clip 64 being attached or connected to the joining member 78). Non-detection of the connection of the harness 60, lanyard 62, or clip 64 to the lift device 20, lift platform 30, or railing 32 may also correspond to non-connection of the harness 60, lanyard 62, or clip 64 to the lift device 20, lift platform 30, or railing 32.

The switch 74 has a first position or state 82 and a second position or state 84. The switch 74 is operable to detect a connection or attachment of the lanyard 62, or more generally a connection or attachment of the harness 60, to the lift device 20, lift platform 30, or railing 32 when in the first state 82. The switch 74 is also operable to detect a non-connection or non-attachment of the lanyard 62, or more generally a non-connection or non-attachment of the harness 60, to the lift device 20, lift platform 30, or railing 32 when in the second state 84.

The safety harness connection detector 56 may further comprise an extension, arm, protrusion, or extension arm 86 extending therefrom. More specifically, the extension arm 86 may be connected to the switch 74 and may extend away from the housing 68 and toward and/or adjacent to the designated location 76 (e.g., the joining member 78). The extension arm 86 is operable to transition the switch 74 to the first state 82 upon displacement of the extension arm 86 via the lanyard 62, or more generally via the harness 60, when the lanyard 62, or more generally the harness 60, is connected to the lift device 20, lift platform 30, or railing 32 (e.g., when the clip 64 is connected to the joining member 78). The extension arm 86 is also operable to transition the switch 74 to the second state 84 upon non-displacement of the extension arm 86 via the lanyard 62, or more generally via the harness 60, when the lanyard 62, or more generally the harness 60, is disconnected to the lift device 20, lift platform 30, or railing 32 (e.g., when the clip 64 is disconnected from the joining member 78).

The safety harness connection detector 56 may further comprise a first light source 88. The first light source 88 may be disposed on and/or attached to the housing 68. The first warning (e.g., the warning issued by non-detection of the connection of the lanyard 62, or more generally non-detection of the connection of the harness 60, to the lift device 20, lift platform 30, or railing 32) may correspond to illuminating the first light source 88. The first light source 88 may comprise any type of light source, including but not limited to light emitting diodes (LEDs), incandescent bulbs, fluorescent lamps, and halogen lamps.

The safety harness connection detector 56 may further comprise a sound source 90. The sound source 90 may be disposed on and/or attached to the housing 68. The second warning (e.g., the warning issued by non-detection of the connection of the lanyard 62, or more generally non-detection of the connection of the harness 60, to the lift device 20, lift platform 30, or railing 32 and the engagement of the switch 72) may correspond to emitting sound from the sound source 90. The sound source 90 may comprise any type of sound source, including but not limited to speakers, horns, and acoustic transducers.

The safety harness connection detector 56 may also be configured to generate or issue a third warning in response to detection of the connection of the lanyard 62, or more generally in response to detection of the connection of the harness 60, to the lift device 20, lift platform 30, or railing 32 (e.g., connection of the clip 64 to the joining member 78). The safety harness connection detector 56 may further comprise a second light source 92. The second light source 92 may be disposed on and/or attached to the housing 68. The third warning (e.g., the warning issued by detection of the connection of the lanyard 62, or more generally detection of the connection of the harness 60, to the lift device 20, lift platform 30, or railing 32) may correspond to illuminating the second light source 92. The second light source 92 may comprise any type of light source, including but not limited to light emitting diodes (LEDs), incandescent bulbs, fluorescent lamps, and halogen lamps.

The first light source 88 and the second light source 92 may be different light sources or may be the same light source that transitions between different colors based on detection or non-detection of the lanyard 62, or more generally the harness 60, on the lift device 20, lift platform 30, or railing 32. If the first light source 88 and the second light source 92 are a common light source, particularly when viewed externally from the safety harness connection detector 56, the common light source may include different internal light sources (e.g., LEDs) that produce different colors of light. For example, the first light source 88, and hence the first warning, may correspond to activating or flashing a red light while the second light source 92, and hence the third warning, may correspond to activating or flashing a green light.

Under some configurations, movement of the lift platform 30, or more generally movement of the lift device 20, via the operator input 40 is enabled in response to non-detection of the connection of the lanyard 62, or more generally non-detection of the connection of the harness 60, to the lift device 20, lift platform 30, or railing 32 (corresponding to switch 74 being in the second state 84) and engagement of the switch 72. However, under such a configuration, the first warning (e.g., illuminating the first light source 88) may remain active while the lift device 20 is being operated. Under other configurations, movement of the lift platform 30, or more generally movement of the lift device 20, via the operator input 40 is disenabled in response to non-detection of the connection of the lanyard 62, or more generally non-detection of the connection of the harness 60, to the lift device 20, lift platform 30, or railing 32 (corresponding to switch 74 being in the second state 84) regardless if switch 72 is engaged or disengaged.

The lift device 20 may further include a power or ignition switch 94. All operation of the lift device 20 (e.g., movement of the lift platform 30, or more generally movement of the lift device 20) may require the ignition switch 94 to be in an “ON” position. All operation of the lift device 20 (e.g., movement of the lift platform 30, or more generally movement of the lift device 20) may be disabled when the ignition switch 94 is in an “OFF” position.

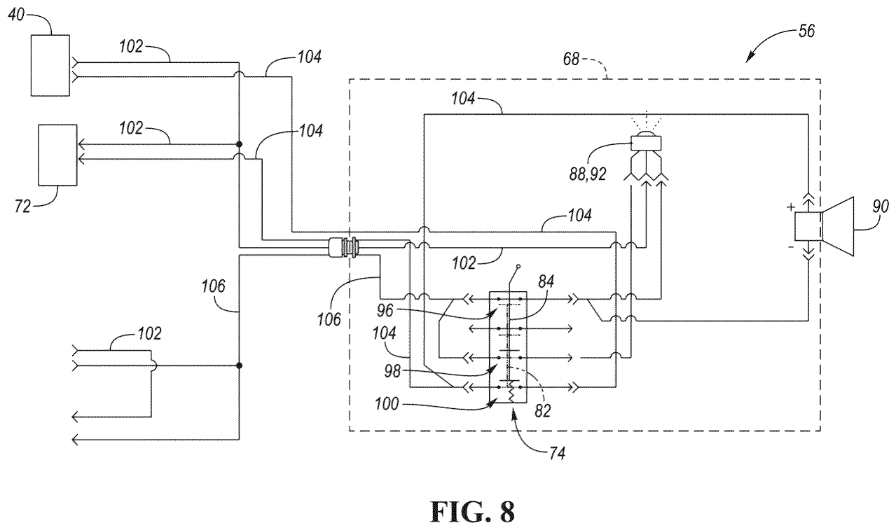

Referring to FIG. 8, a wire diagram of the electrical elements of the safety harness connection detector 56 and electrical connections between the electrical elements of the safety harness connection detector 56 and the lift device 20 are illustrated. The switch 74 is shown in the second state 84 in solid lines and in the first state 82 in phantom lines. The switch 74 includes several internal switches or contacts.

In the second state 84, a first of the contacts 96 connects the first light source 88 and the sound source 90 to an electrical power source such that electrical power is delivered to the first light source 88. The sound source 90, however, is further connected to switch 72. Therefore, electrical power is only delivered to the sound source 90 via the first of the contacts 96 when switch 74 is in the second state 84 and when switch 72 is engaged. In the first state 82, the first of the contacts 96 disconnects both the first light source 88 and the sound source 90 from the electrical power source.

In the first state 82, a second of the contacts 98 connects the second light source 92 to the electrical power source such that electrical power is delivered to the second light source 92. In the second state 84, the second of the contacts 98 disconnects second light source 92 from the electrical power source.

In the first state 82, a third of the contacts 100 connects the operator input 40 to the electrical power source such that electrical power is delivered to the operator input 40. The operator input 40, however, is further connected to switch 72. Therefore, electrical power is only delivered to the operator input 40 via the third of the contacts 100 when switch 74 is in the first state 82 and when switch 72 is engaged. In the second state 84, the third of the contacts 100 disconnects operator input 40 from the electrical power source. It is noted that the third of the contacts 100 may be optionally connected to the operator input 40 or may be omitted entirely. In such a configuration where the third of the contacts 100 may not connected to the operator input 40 or is omitted, power may be delivered to the operator input 40 for engagement to move the lift platform 30, or more generally to move the lift 20, regardless of the state of switch 74 as long as switch 72 is engaged.

Power or hot wires within the circuit that are connected to a power source (e.g., a positive terminal of a battery or positive side of an alternator or generator) are labelled as wires 102. Signal wires (e.g., wires that complete a circuit by establishing a connection to a device that is external to the safety harness connection detector 56, such as the operator input 40 or switch 72, based on the state of switch 74) are labelled as wires 104. The wires that are connected to ground (e.g., ground wires) are labelled as wires 106.

It should be understood that the designations of first, second, third, fourth, etc. for any component, state, or condition described herein may be rearranged in the claims so that they are in chronological order with respect to the claims. Furthermore, it should be understood that any component, state, or condition described herein that does not have a numerical designation may be given a designation of first, second, third, fourth, etc. in the claims if one or more of the specific component, state, or condition are claimed.

The words used in the specification are words of description rather than limitation, and it is understood that various changes may be made without departing from the spirit and scope of the disclosure. As previously described, the features of various embodiments may be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. A lift comprising:
a base;
a work platform attached to and movable relative to the base;
a human machine interface (i) attached to the work platform and (ii) operable for controlling movement of the work platform;
a switch (i) attached to the work platform, (ii) operable to enable movement of the work platform via the human machine interface when engaged by a user, and (iii) operable to disable movement of the work platform when disengaged by a user; and
a detector (i) attached to the work platform, (ii) operable to detect a connection of a safety harness lanyard to the work platform, (iii) operable to issue a first warning in response to non-detection of the connection of the safety harness lanyard to the work platform, and (iv) operable to simultaneously issue the first warning and a second warning in response to non-detection of the connection of the safety harness lanyard to the work platform and engagement of the switch.

2. The lift of claim 1, wherein the detector further comprises a light source and the first warning comprises illuminating the light source.

3. The lift of claim 2, wherein the detector further comprises a sound source and the second warning comprises emitting sound from the sound source.
The lift of claim 1, wherein the detector is further operable to issue a third warning in response to detection of the connection.

5. The lift of claim 4, wherein the detector further comprises first and second light sources, the first warning comprises illuminating the first light source, and the third warning comprises illuminating the second light source.

6. The lift of claim 1, wherein movement of the work platform via the human machine interface is enabled in response to non-detection of the connection of the safety harness lanyard to the work platform and engagement of the switch.

7. The lift of claim 1, wherein the detector is further operable to disable movement of the work platform via the human machine interface in response to non-detection of the connection of the safety harness lanyard to the work platform and engagement of the switch.

8. The lift of claim 1, wherein the switch comprises a foot pedal.

9. The lift of claim 1, wherein the detector further comprises a limit switch (i) having first and second states, (ii) operable to detect the connection of the safety harness lanyard to the work platform when in the first state, and (iii) operable to detect a non-connection of the safety harness lanyard to the work platform when in the second state.

10. The lift of claim 9, wherein (i) the detector further comprises an arm extending therefrom, (ii) the arm is operable to transition the limit switch to the first state upon displacement of the arm via the safety harness lanyard when the safety harness lanyard is connected to the work platform, and (iii) the arm is operable to transition the limit switch to the second state upon non-displacement of the arm via the safety harness lanyard when the safety harness lanyard is disconnection from the work platform.

11. A safety harness connection detector for a lift comprising:
a switch operable to detect an attachment of a safety harness to the lift at a designated location on the lift, wherein the safety harness connection detector is operable to generate a first warning in response to non-attachment of the safety harness at the designation location, and wherein the safety harness connection detector is operable to generate a second warning collectively with the first warning in response to non-attachment of the safety harness at the designation location and engagement of a secondary switch that is configured to enable operation of the lift.

12. The safety harness connection detector of claim 11 further comprising a light source, and wherein the first warning comprises illuminating the light source.

13. The safety harness connection detector of claim 12 further comprising a sound source, and wherein the second warning comprises emitting sound from the sound source.

14. The safety harness connection detector of claim 11, wherein the switch is further operable to disable operation of the lift in response to non-attachment of the safety harness at the designation location and engagement of the secondary switch.

15. The safety harness connection detector of claim 11, wherein the safety harness connection detector is operable to generate a third warning in response to attachment of the safety harness at the designation location.

16. A safety harness connection detector for a lift comprising:
a housing operable for connection to the lift;
a limit switch (i) disposed within the housing and (ii) operable to detect an attachment of a safety harness to the lift at a designated location on the lift; and
an extension arm (i) connected to the limit switch, (ii) extending away from the housing, (iii) operable to extend toward the designated location on the lift, (iv) operable to, in response to displacement of the extension arm, transition the limit switch to a first state corresponding to detection of the attachment of the safety harness to the lift at the designated location, and (v) operable to, in response to non-displacement of the extension arm, transition the limit switch to a second state corresponding to non-detection of the attachment of the safety harness to the lift at the designated location.

17. The safety harness connection detector of claim 16 further comprising a light source secured to the housing, wherein the light source is operable to illuminate in response to the limit switch being in the second state.

18. The safety harness connection detector of claim 17 further comprising a sound source secured to the housing, wherein the sound source is operable to emit sound in response to the limit switch being in the second state and engagement of a secondary switch that is configured to enable operation of the lift.

19. The safety harness connection detector of claim 17 further comprising a second light source secured to the housing, wherein the second light source is operable to illuminate in response to the limit switch being in the first state.

20. The safety harness connection detector of claim 16, wherein the limit switch is further operable to disable operation of the lift in response to the limit switch being in the second state and engagement of a secondary switch that is configured to enable operation of the lift.
